(19) United States
(12) Patent Application Publication
(10) Pub. No.: US 2003/0084599 A1
(43) Pub. Date: May 8, 2003

(54) Restroom display systems

(76) Inventor: Rafael Elul, San Francisco, CA (US)

Correspondence Address: Rafael Elul, P.O. Box 882941, San Francisco, CA, 94188, US

(21) Appl. No.: 10/008,169

(22) Filed: Nov. 5, 2001

(51) Int. Cl. G09F 27/00

(52) U.S. Cl. 40/455

(57) ABSTRACT

A system for delivering audio, visual, or audiovisual entertainment, educational material and advertising to users of public and private restrooms, including visual images, and or sound programming, throughout the restroom or in discrete areas thereof, placed so that the images and/or sound can be conveniently seen and/or heard by users of these facilities. Optionally the system may be programmed to turn on when the restroom facilities are being used, and to be turned off either when the facility is vacated, or after a set time has elapsed.

### BACKGROUND

Restroom design in private residences commonly includes a built-in bookshelf in consideration of the habit (reportedly more common among males) of reading while sitting on the toilet.

Restrooms in public buildings do not have similar conveniences. Certain public restroom users bring to the restroom books, magazines, or newspapers, but the majority of users do not have reading material at hand. For that majority, the public restroom experience would be rendered significantly more enjoyable, if facilities were available in the restroom for display of text and/or images at an appropriate size and location for convenient viewing while seated on the toilet.

Displays of this type in public restrooms have also substantial economic value as a venue for advertising. From an advertiser's viewpoint, restroom displays have a number of attractive attributes: First, unlike standard television advertising, restroom displays literally have a “captive audience” for the duration of use of the restroom. Not only are users without company and absent of distractions, but “channel hopping”, excursions to the kitchen, etc., are not an option in that environment. Second, advertising in public restrooms lends itself to targeting by occupation, by gender, and in many cases also by income level. Restrooms in office buildings housing attorney offices, for example, are primarily used by individuals in the legal professions, and advertising can be tailored to that specific audience. Similarly, staff restrooms in hospitals are used by physicians, nurses and other health professionals; restrooms in the symphony hall are used by individuals of well-defined cultural tastes, etc. Moreover most public buildings contain two sets of gender-specific restrooms, providing a ready venue for gender-oriented advertising. If properly structured, advertising in public restrooms can contribute substantially to the public good, since the revenue generated by such advertising, provides a strong incentive to open to public use additional restrooms, and to keep restrooms more attractive, cleaner, and better maintained. Accordingly, the goal of the present invention is to provide public restrooms display systems, which enhance users' overall restroom experience, while acting as an effective vehicle for advertising.

### PRINCIPLE OF THE INVENTION

Restroom displays can be of three basic types, differing in initial investment, in the requirements for and the cost of maintenance, and in their efficacy as an entertainment and advertising vehicle:

1. Static displays: Posters and similar placards, mounted on the door or wall, and positioned so as to be conveniently visible to toilet or urinal users. Initial investment requirements for displays of this type are low, but the need to have posters changed periodically contributes to high programming and maintenance cost. Moreover, as an entertainment as well as advertising vehicle, static posters have only limited user appeal.

2. Mechanically-powered displays: Sequential sets of posters mounted in a display with scrolling capability. Rotating slat display systems, which alternate between three different images, offer similar if somewhat more limited functionality. Devices of this type require some power source. The power required for changing the display may be derived from mechanical coupling to the restroom door, and be stored in e.g. a spring each time the door is opened or closed. However, any associated audio programming would still require electric power. The initial investment and the programming and maintenance costs of such displays, vary from intermediate to very high, depending on the level of mechanical complexity of the display mechanism.

3. Video displays: television screens and projected movie images. These displays require significant initial investment, but subsequent programming and maintenance are not costly. Moreover video displays offer essentially unlimited range of programming capabilities, making possible e.g. different programming for different segments of the day. Also, the growing availability of flat display panels, and of ultra-slim television sets, makes it practical for such panels and near-flat television sets to be incorporated in restroom doors or walls with only minimal change to the existing structures. In view of these advantages of video displays, and the rapidly falling price of flat display panels and the corresponding electronic control systems, video displays most assuredly represent the preferred embodiment of the present invention.

Any of the three display types listed above, can be made available either with or without audio. To retain tranquility in the restroom, audio may be provided via directional loudspeakers, since the position of the user's head while using the toilet, urinal, washbasin and the powder room makeup table, can be predicted with fair accuracy.

In summary, displays of any type placed in public restroom doors or walls, may provide an alternative to books, newspapers, or other reading material. With an added keyboard, video displays are even capable of providing computer access in the restroom, which may be helpful in certain mission-critical environments. In public areas, panels incorporated in the restroom door or wall, may be used for dissemination of educational content, advertising material, emergency information, and visual entertainment, which will render the restroom experience more enjoyable, and at the same time may help defray the cost of restroom deployment and upkeep.

### DETAILS OF THE INVENTION

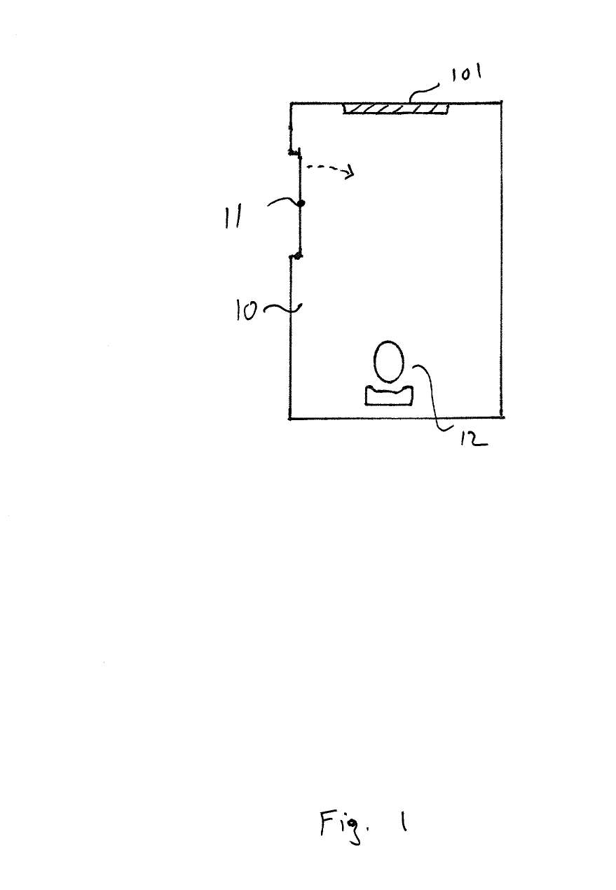

FIG. 1 presents the typical layout of a restroom 10 according to the present invention, with toilet 12. The chief innovative feature is the display panel 101 set into the door 11 or into the wall 10, depending on the rest room floor plan.

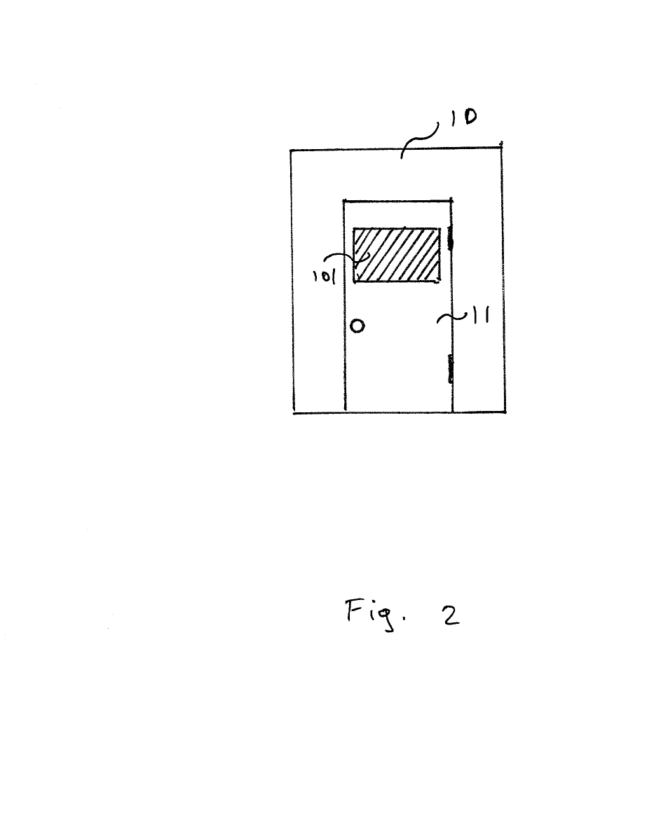

FIG. 2 presents the restroom door 11, with the inset display or near-flat television set 101, as seen by an individual seated on the toilet.

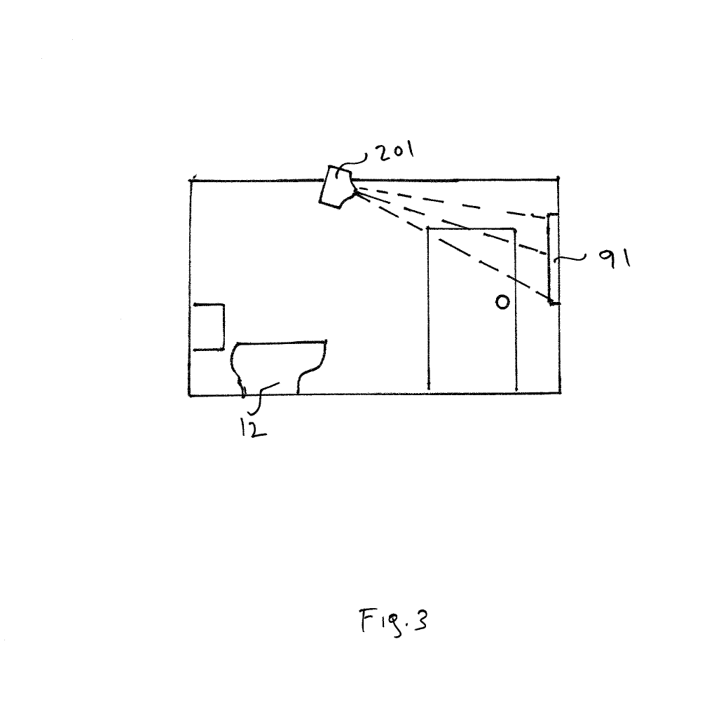

FIG. 3 illustrates an alternative embodiment, where the restroom door contains only a passive reflective surface 91, on which the image is projected from a television set or liquid crystal video projector 201, located above and behind the toilet 12. If desired, holographic images also may be readily projected on the same reflective surface, since the viewer's position is strictly controlled by the layout of the restroom.

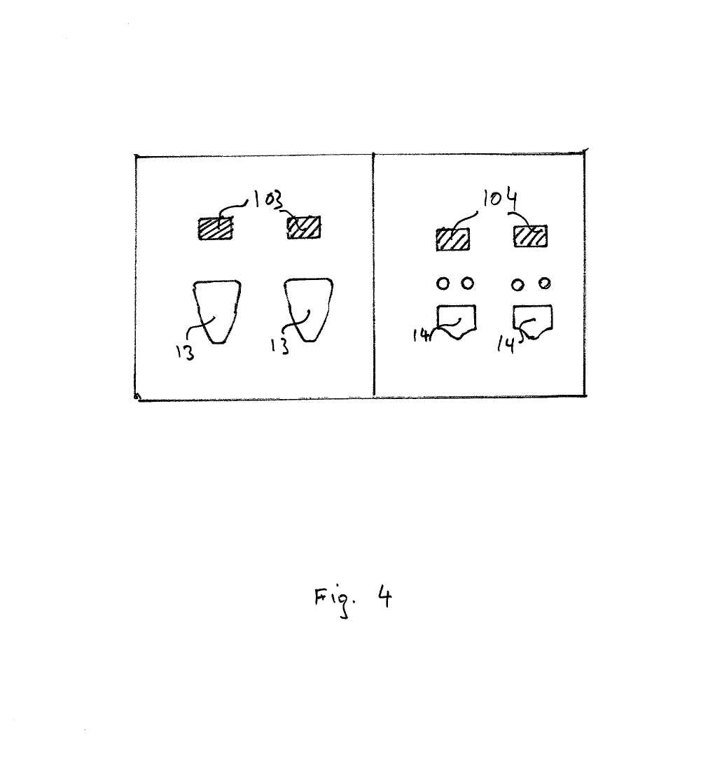

FIG. 4 illustrates a setup suitable for urinals and washbasins, showing urinal 13, washbasin 14 and the corresponding displays 103, 104. While the duration of exposure of a urinal user to the image typically is brief, this device may be suitable for providing the user with certain types of advertising, or with images of nature, e.g. rivers, creeks, waterfalls, and the like, or for brief visual advertising.

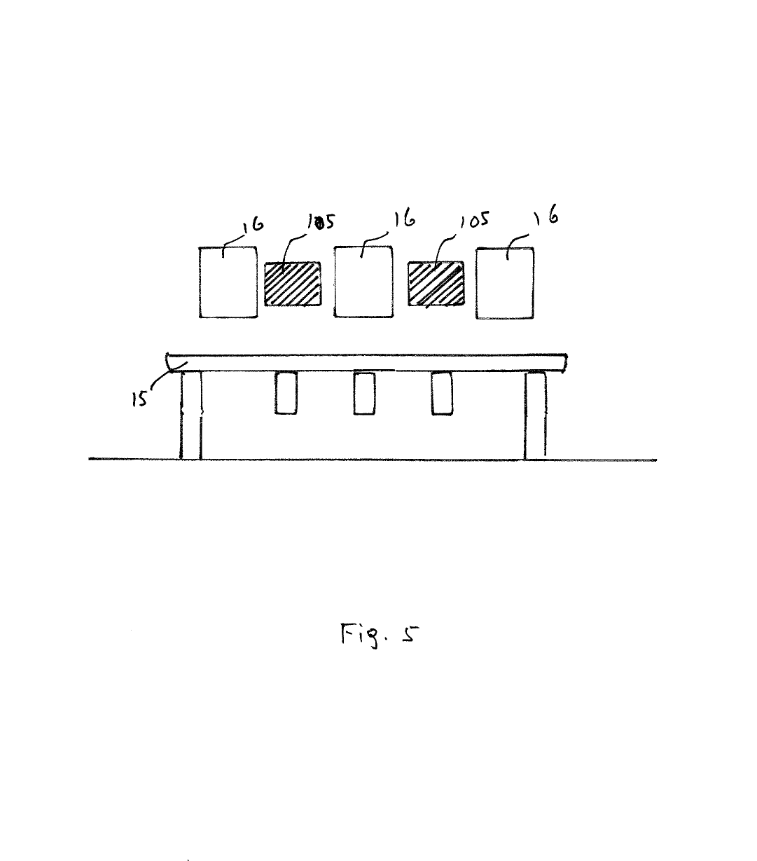

FIG. 5 illustrates displays placed in a powder room environment. The displays 105 are located above the makeup counter 15, between individual make-up mirrors 16.

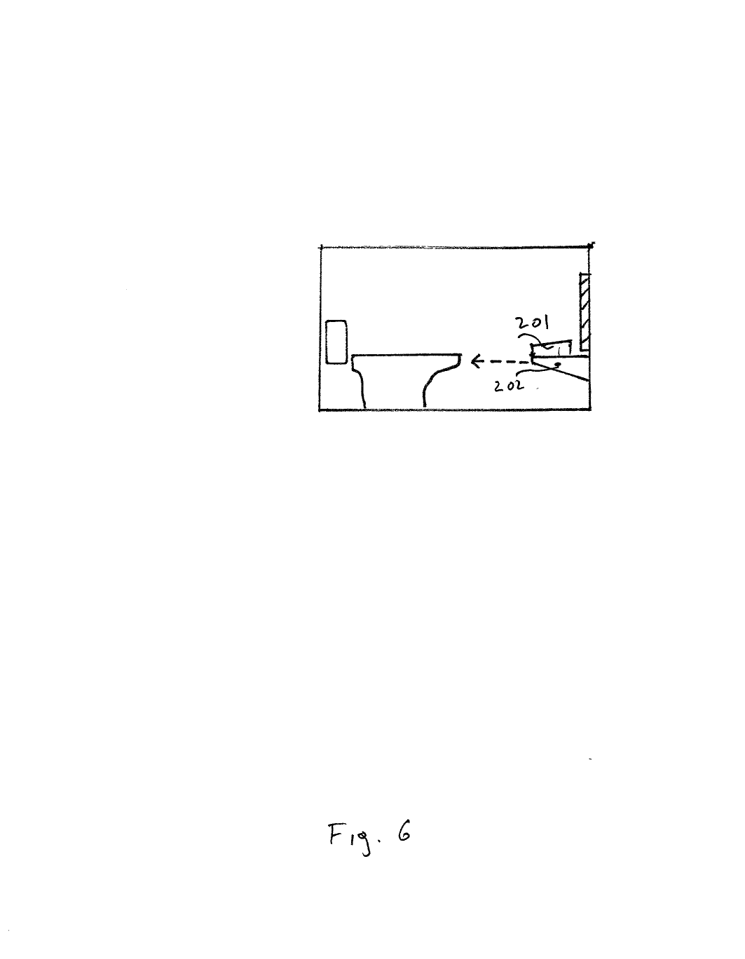

FIG. 6 illustrates the addition of a keyboard 201, on a sliding platform 202, which allows control of mission-critical computer systems from within the restroom.

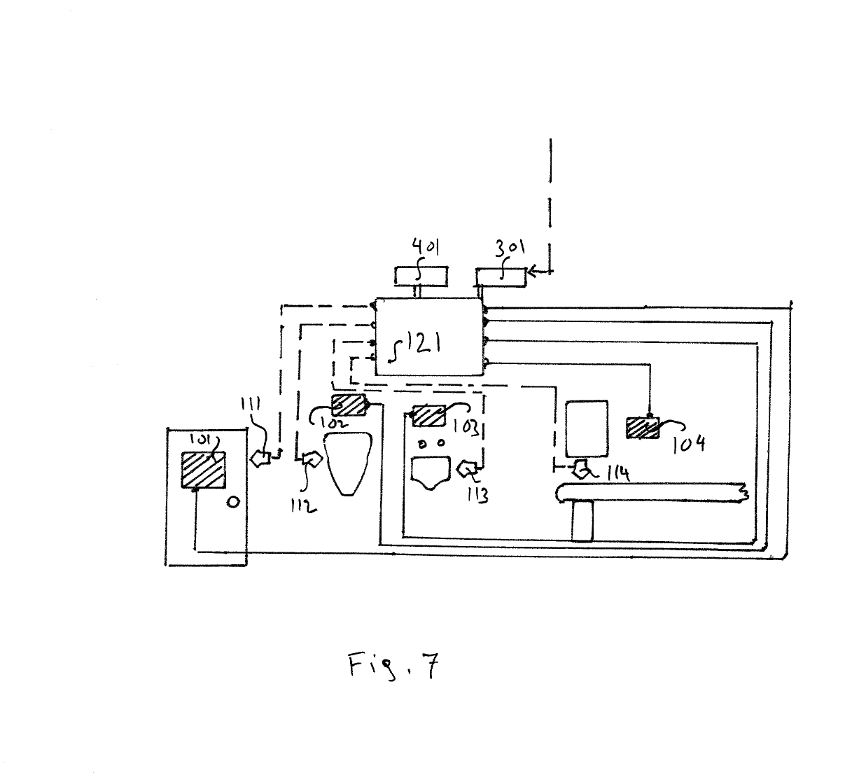

FIG. 7 presents the control system for restroom displays. A micro-switch 111, activated by closing the door, or a proximity switch 112 activated by an individual approaching the urinal, a proximity switch 113 activated by approach to washbasin, or a proximity switch 114 triggered by sitting down at the makeup counter, sends a signal to the control unit 121. The control unit identifies the location involved, and activates the appropriate associated display 101, 102, 103, or 104, sending programming appropriate in subject as well as duration. The time the display remains active is controlled by timing unit 401, which can be set appropriately to different environments, and is important in encouraging toilet users to vacate the restroom after a fixed period of time. The control unit 121 may have its programming refreshed via input interface 301, capable of connecting e.g. to local network, wireless network, or CATV.

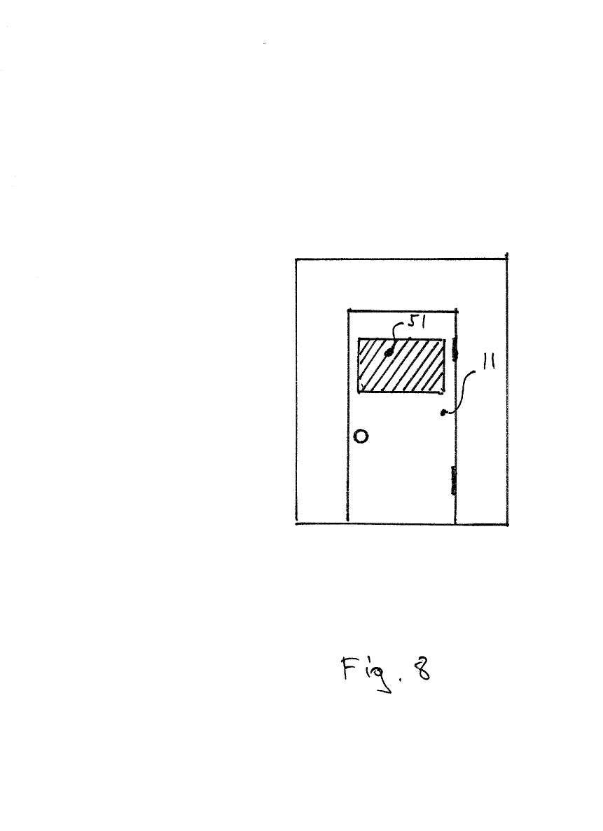

FIG. 8 illustrates a passive restroom display. Similar to video displays, but in an environment where a video display is not desired or not feasible, a poster 51 is placed on the restroom door 11, in a location convenient for observation by restroom users.

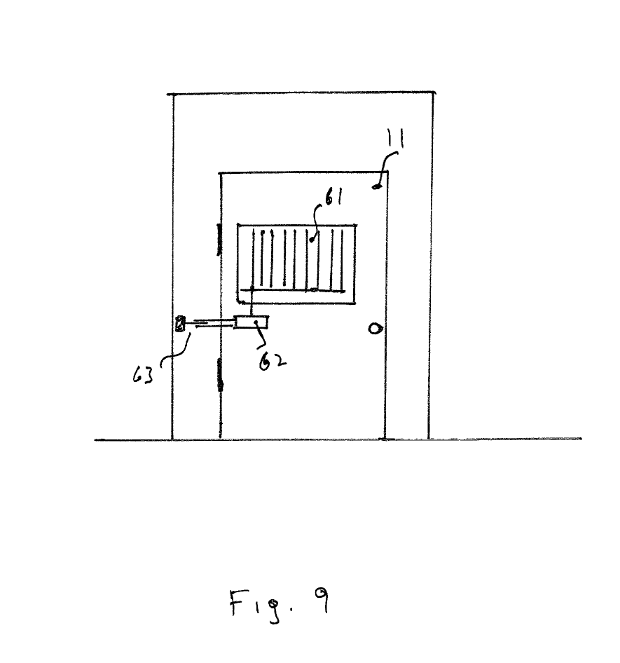

FIG. 9 presents a mechanized slat display 61, which is changed by a spring movement 62. Display is started by mechanical linkage 63 activated by closing of restroom door 11.

### SCOPE OF THE INVENTION

The innovation of the present invention, namely the introduction of video programming to restrooms, is not limited to public facilities. The progressive shift from reading to television is likely to be manifested also in residential restroom preferences. Private restrooms, while having much reduced usage compared to public facilities, retain the advantage of “captive audience”, and it is quite possible, and indeed probable, that the introduction of television programming to public restrooms may lead a substantial percentage of the population to request similar programming in the residential environment. Such eventual expansion of the use of video displays in restrooms falls quite naturally within the scope of the present invention.

1. A system for delivering entertainment, educational materials and advertising in restroom facilities, comprising:
(A) a source or plurality of sources of entertainment, educational material, and advertising including any of the two following, singly or in combination:
(a) display of visual images, including but not limited to:
(i) text
(ii) still pictures
(iii) moving pictures
(b) auditory material, including but not limited to:
(i) verbal messages
(ii) music
(B) placement of said source or plurality of sources of entertainment, educational material and advertising in, or substantially proximal to, toilets, urinals, washbasins, grooming areas and powder rooms, where said entertainment, educational material and advertising are clearly visible and/or audible to users of said toilets, urinals, washbasins, grooming areas and powder rooms
whereby said users of said restroom facilities are presented with entertainment, educational material, and advertising while using said restroom facilities.

2. The system of claim 1 with means for programming the source or plurality of sources of entertainment, educational material, and advertising, comprising the following, singly or in combination:
(A) a switching means to turn on said source or sources, based on presence of a user or users of said restroom facilities
(B) a timing to turn off said source or sources when said user or users have left said restroom facilities or after a set interval since having been turned on
(C) a programming means to change over time the material being broadcast from said source or sources while said source or sources are turned on by said switching means
whereby said users of said restroom facilities are presented with entertainment, educational material, and advertising of determined content and duration in the course of using said restroom facilities.

3. The system of claim 1, with the addition of a keyboard and link to a computer system or systems, whereby providing access to said computer systems while using said restroom facilities.

4. A system for delivering entertainment, educational material, and advertising in restroom facilities, where said system includes display of visual material, including text and/or still or moving pictures, and/or auditory information, where said visual and/or audio material is displayed in position convenient for viewing and/or listening by users of said facilities, whereby said users of said restroom facilities, including but not limited to toilets, urinals, washbasins, baths, showers, and powder rooms, are presented with entertainment, educational material, and/or advertising while using said restroom facilities.

5. The system of claim 4, where said visual and/or auditory information is changed while the restroom is being used by an individual user, whereby the overall amount of visual and/or sound information presented to said user is increased.

6. The system of claim 4, where said visual and/or auditory information is changed based on a time schedule, whereby the overall amount of visual and/or sound information presented to a plurality of restroom users is increased.

7. The system of claim 4, with the addition of a keyboard, whereby providing access to computer systems from the restroom environment.

8. Restrooms equipped with means to present an image, or a plurality of images, whether still images or moving images, whether with or without accompanying sound, where said image or images are placed to be conveniently seen by the user of the restroom, whether using toilet, urinal, washbasin, or powder room, whereby said users of said restroom facilities are presented with entertainment, educational material, and/or advertising.

9. The system of claim 8, providing entertainment, advertising, or any other information.

10. The system of claim 8, with the addition of a keyboard, whereby providing access to computer systems from the restroom environment.
